(19) United States
(12) Patent Application Publication
(10) Pub. No.: US 2025/0318531 A1
(43) Pub. Date: Oct. 16, 2025

(54) PHOSPHOR FOR PROMOTING PLANT GROWTH, PREPARATION METHOD, USING METHOD AND APPLICATION THEREOF

(71) Applicant: Lanzhou University, Lanzhou (CN)

(72) Inventors: Yuhua Wang, Lanzhou (CN); Takatoshi Seto, Lanzhou (CN); Chengcheng Li, Lanzhou (CN)

(73) Assignee: Lanzhou University, Lanzhou (CN)

(21) Appl. No.: 19/249,011

(22) Filed: Jun. 25, 2025

Related U.S. Application Data
(63) Continuation of application No. PCT/CN2025/100873, filed on Jun. 13, 2025.

(51) Int. Cl. A01N 59/26; A01P 21/00

(52) U.S. Cl. CPC A01N 59/26; A01P 21/00

(57) ABSTRACT

The present invention discloses a phosphor for promoting plant growth, preparation method, using method and application thereof, and belongs to the technical field of light-emitting materials. The phosphor prepared by the present invention can emit deep red light under the irradiation of near-ultraviolet light and sunlight. An excitation spectrum of the phosphor basically covers the entire visible light region, which can effectively convert sunlight into the red light required by plants, improve the utilization rate of sunlight by plants, and promote plant growth.

### TECHNICAL FIELD

The present invention relates to the technical field of light-emitting materials, particularly a phosphor for promoting plant growth, a preparation method, a using method and an application thereof.

### BACKGROUND

As a crucial environmental factor for plant growth and development, light serves not only as an essential source of photosynthesis in plants but also as a key regulatory factor in the process of plant growth and development. Plants are not only restricted by the intensity of sunlight, but also affected by the light quality in the process of plant growth and development. Blue light, red light, and far-red light play a key role in controlling plant photomorphogenesis as plants do not require all wavelengths of light, primarily requiring red light (600-700 nm) and far-red light (700-750 nm) as well as the blue light (400-500 nm) portion from sunlight. In photosynthesis, blue light can stimulate the absorption of chlorophyll b, manifesting as the promotion of plant metabolism. Red light can promote plant flowering and fruit ripening, while far-red light controls the entire life cycle of plants from germination to maturity. Light in other regions is basically not absorbed by plants, so it can be seen that the efficiency of plant utilization of sunlight is very limited. It is of great significance for plant growth and development through exploring how to improve the utilization rate of sunlight by plants.

Phosphor for plant growth is a type of light-conversion agent, that belongs to the photoluminescence light-emitting materials, specifically referring to phosphors that rely on external light sources for illumination to obtain energy and emit light required by plant growth. Therefore, phosphors play an essential role in agricultural production. At present, phosphors for plant growth are typically used as light-emitting diode (LED) plant growth lamps, while the commonly available LED plant growth phosphors with good performance on the commercial market typically employ expensive nitrides and oxynitrides to promote plant growth and development through artificial supplementary lighting. On the one hand, the synthesis process of nitride (oxide) phosphors is relatively complex with stringent synthesis conditions, which greatly limits their practical application; on the other hand, mass-produced plant LED lights require extremely high power resources, resulting in increased additional costs for agricultural crops, and the applicable agricultural environment is relatively stringent, making it difficult to apply them on a large scale.

In view of the above, it is necessary to develop a novel phosphor for plant growth with high efficiency and low cost.

### SUMMARY

An objective of the present invention is to provide a phosphor for promoting plant growth, preparation method, using method and application thereof, the phosphor prepared by the present invention can emit deep red light under the irradiation of near-ultraviolet light and sunlight. An excitation spectrum of the phosphor basically covers the entire visible light region, which can effectively convert sunlight into the red light required by plants, improve the utilization rate of sunlight by plants, and promote plant growth.

In order to achieve the above objective, the present invention provides a phosphor for promoting plant growth, a chemical expression of the phosphor is Ca₂₋₂ₓNaₓGdₓMgWO₆:yMn⁴⁺, where 0.1≤x≤0.6, 0.1%≤y≤1.1%.

Preferably, the chemical expression of the phosphor is Ca_{0.8}Na_{0.6}Gd_{0.6}MgWO₆:0.5% Mn⁴⁺.

The present invention provides a using method for the phosphor for promoting plant growth, and a light-conversion film made of the phosphor converts received sunlight into red light in a wavelength range of 600-800 nm.

The present invention provides a preparation method for the phosphor for promoting plant growth, including the following steps:
S1, weighing raw materials according to the general chemical formula Ca₂₋₂ₓNaₓGdₓMgWO₆:yMn⁴⁺, 0.1≤x<0.6, 0.1%≤y≤1.1% in a stoichiometric ratio, the raw materials includes calcium compounds, sodium compounds, gadolinium compounds, magnesium compounds, tungsten compounds and manganese compounds, mixing the above compounds uniformly and adding a flux, then mixing with ethanol to obtain mixed raw materials by grinding and drying;
S2, placing the mixed raw materials prepared in step S1 in a tube furnace at a heating rate of 5° C./min to 1280° C. and holding the temperature for 4 hours, then cooling in the furnace to room temperature to obtain a calcined product; and
S3, obtaining the phosphor by grinding the calcined product.

Preferably, the calcium compounds include one or more of calcium carbonate, hydroxides of calcium, nitrates of calcium, carbonates of calcium, sulfates of calcium, and phosphates of calcium;
the sodium compounds include one or more of sodium carbonate, hydroxides of sodium, nitrates of sodium, carbonates of sodium, sulfates of sodium, or phosphates of sodium;
the magnesium compounds include one or more of magnesium oxide, hydroxides of magnesium, nitrates of magnesium, carbonates of magnesium, sulfates of magnesium, and phosphates of magnesium;
the gadolinium compounds include one or more of gadolinium oxide, hydroxides of gadolinium, nitrates of gadolinium, carbonates of gadolinium, sulfates of gadolinium, and phosphates of gadolinium;
the tungsten compounds include one or more of ammonium tungstate, hydroxides of tungsten, nitrates of tungsten, carbonates of tungsten, sulfates of tungsten, and phosphates of tungsten;
the manganese compounds include one or more of manganese carbonate, hydroxides of manganese, nitrates of manganese, carbonates of manganese, sulfates of manganese, and phosphates of manganese.

Preferably, the flux is 2-10 wt % sodium fluoride.

The present invention provides an application for the phosphor for promoting plant growth in plant growth.

Preferably, the phosphor is made into a light-conversion film when used for lettuce growth, and at least two of the light-conversion films are uniformly arranged around a bottom of the lettuce plant and other placement manners, an angle between the light-conversion film and a horizontal plane is between 25°-45°.

Therefore, the present invention adopts the above-mentioned phosphor for promoting plant growth, preparation method, using method and application thereof. The phosphor is prepared by the strategy of aliovalent cation co-substitution, Ca₂MgWO₆ is used as the matrix, with Na⁺ and Gd³⁺ respectively substituting Ca²⁺ sites, and Ca₂₋₂ₓNaₓGdₓMgWO₆:yMn⁴⁺ phosphor is successfully prepared. The doping of Na⁺ and Gd³⁺ successfully breaks the structural symmetry around Mn4+, overcomes the forbidden transition of three-dimensional (3D) orbitals, reduces energy loss from nonradiative transitions, and significantly enhances luminescence performance, so that the luminescence intensity is increased by nearly 10 times compared to the unmodified state, with the following advantages:
1. The raw materials have extensive sources and low prices, which can effectively reduce costs and can be mass-produced.
2. The preparation method is simple, high efficiency, low device requirements, green environmental protection and no pollution.
3. The excitation spectrum of the phosphor basically covers the entire visible light region, which can effectively convert sunlight into the red light required by plants, improve the utilization rate of sunlight by plants, and promote plant growth.
4. The phosphor can directly utilize and convert sunlight without combining with chips, and there is no energy consumption during use. Meanwhile, it can also be used as a light-conversion film for plant growth to convert into the red light mainly required by plants.
5. The phosphor is prepared by the new strategy of aliovalent cation co-substitution, thereby greatly improving the quantum efficiency of the phosphor.

Further detailed descriptions of the technical scheme of the present invention can be found in the accompanying drawings and embodiments.

### BRIEF DESCRIPTION OF THE DRAWINGS

The accompanying drawings are incorporated into and form part of the specification, showing experimental examples in accordance with the present application, and are used together with the specification to explain the principles of the present application.

FIG. 1 is a comparison diagram of an X-ray diffraction (XRD) pattern and a standard powder diffraction file of a deep red phosphor for plant growth prepared in experimental examples 1-6;

FIG. 2 is an excitation and an emission spectrum of a deep red phosphor for plant growth prepared in experimental examples 1-6;

FIG. 3 is a comparison diagram of an XRD pattern and a standard powder diffraction file of the deep red phosphor for plant growth prepared in experimental examples 5 and 8-12;

FIG. 4 is an emission spectrum of a deep red phosphor for plant growth prepared in experimental examples 5 and 8-12;

FIG. 5 is a comparison diagram of an XRD pattern and a standard powder diffraction file of a phosphor prepared in comparative example 1;

FIG. 6 is a comparison diagram of an emission spectrum of a phosphor in experimental example 5 and comparative example 1;

FIG. 7 is an emission spectrum of a deep red phosphor for plant growth prepared in experimental examples 5 and 13-19;

FIG. 8 is an emission spectrum of a deep red phosphor for plant growth prepared in experimental examples 5, 13 and examples 1-4;

FIG. 9 is a spectrum diagram of sunlight;

FIG. 10 is an excitation-emission spectrum of Ca₂₋₂ₓNaₓGdₓMgWO₆:Mn⁴⁺ of the present invention;

FIG. 11 is an experimental diagram of promoting lettuce growth using light-conversion films;

FIG. 12 is a comparison diagram of lettuce leaf maturity obtained from lettuce growth experiments.

### DETAILED DESCRIPTION OF THE EMBODIMENTS

The technical scheme of the present invention is further explained below by drawings and embodiments.

The present invention provides a phosphor for promoting plant growth, the chemical expression of the phosphor is Ca₂₋₂ₓNaₓGdₓMgWO₆:yMn⁴⁺, where 0.1≤x≤0.6, 0.1%≤y≤1.1%. Preferably, the chemical expression of the phosphor is Ca_{0.8}Na_{0.6}Gd_{0.6}MgWO₆:0.5% Mn⁴⁺.

The present invention provides a using method for the phosphor for promoting plant growth, and the light-conversion film made of the phosphor converts received sunlight into red light in the wavelength range of 600-800 nm.

The present invention provides a preparation method for the phosphor for promoting plant growth, including the following steps:
S1, raw materials are weighed according to the general chemical formula Ca₂₋₂ₓNaₓGdₓMgWO₆:yMn⁴⁺, 0.1≤x≤0.6, 0.1%≤y≤1.1% in the stoichiometric ratio, the raw materials includes calcium compounds, sodium compounds, gadolinium compounds, magnesium compounds, tungsten compounds and manganese compounds, the above compounds are mixed uniformly and the flux is added, then mixed with ethanol to obtain mixed raw materials by grinding and drying;
S2, the mixed raw materials prepared in step S1 are placed in the tube furnace at a heating rate of 5° C./min to 1280° C. and the temperature is held for 4 hours, then cooled in the furnace to room temperature to obtain the calcined product; and
S3, the phosphor is obtained by grinding the calcined product.

The calcium compounds includes one or more of calcium carbonate, hydroxides of calcium, nitrates of calcium, carbonates of calcium, sulfates of calcium, and phosphates of calcium; the sodium compounds include one or more of sodium carbonate, hydroxides of sodium, nitrates of sodium, carbonates of sodium, sulfates of sodium, or phosphates of sodium; the magnesium compounds include one or more of magnesium oxide, hydroxides of magnesium, nitrates of magnesium, carbonates of magnesium, sulfates of magnesium, and phosphates of magnesium; the gadolinium compounds include one or more of gadolinium oxide, hydroxides of gadolinium, nitrates of gadolinium, carbonates of gadolinium, sulfates of gadolinium, and phosphates of gadolinium; the tungsten compounds include one or more of ammonium tungstate, hydroxides of tungsten, nitrates of tungsten, carbonates of tungsten, sulfates of tungsten, and phosphates of tungsten; and the manganese compounds include one or more of manganese carbonate, hydroxides of manganese, nitrates of manganese, carbonates of manganese, sulfates of manganese, and phosphates of manganese; the flux is 2-10 wt % sodium fluoride.

The present invention provides an application for the phosphor for promoting plant growth, where the phosphor is made into the light-conversion film when used for lettuce growth, and at least two of the light-conversion films are uniformly arranged around the bottom of the lettuce plant and other placement manners, the angle between the light-conversion film and the horizontal plane is between 25°-45°.

### Experimental Example 1

0.4309 g of CaCO₃ (purity: 99%), 0.0285 g of Na₂CO₃ (purity: 99.8%), 0.0975 g of Gd₂O₃ (purity: 99%), 0.1084 g of MgO (purity: 99.9%), 0.6826 g of (NH₄)₁₀H₂(W₂O₇)₆ (purity: 99.95%) and 0.0015 g of MnCO₃ (purity: 99.95%) were weighed respectively according to the chemical formula Ca_{1.6}Na_{0.2}Gd_{0.2}MgWO₆:0.5% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{1.6}Na_{0.2}Gd_{0.2}MgWO₆:0.5% Mn⁴⁺ was prepared by grinding the sample into powder again after cooling to room temperature.

### Experimental Example 2

0.3671 g of CaCO₃ (purity: 99%), 0.0417 g of Na₂CO₃ (purity: 99.8%), 0.1425 g of Gd₂O₃ (purity: 99%), 0.1056 g of MgO (purity: 99.9%), 0.6647 g of (NH₄)₁₀H₂(W₂O₇)₆ (purity: 99.95%) and 0.0015 g of MnCO₃ (purity: 99.95%) were weighed respectively according to the chemical formula Ca_{1.4}Na_{0.3}Gd_{0.3}MgWO₆:0.5% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{1.4}Na_{0.3}Gd_{0.3}MgWO₆:0.5% Mn⁴⁺ was prepared by grinding the sample into powder again after cooling to room temperature.

### Experimental Example 3

0.3066 g of CaCO₃ (purity: 99%), 0.0541 g of Na₂CO₃ (purity: 99.8%), 0.1851 g of Gd₂O₃ (purity: 99%), 0.1029 g of MgO (purity: 99.9%), 0.6477 g of (NH₄)₁₀H₂(W₂O₇)₆ (purity: 99.95%) and 0.0015 g of MnCO₃ (purity: 99.95%) were weighed respectively according to the chemical formula Ca_{1.2}Na_{0.4}Gd_{0.4}MgWO₆:0.5% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280°° C. The phosphor Ca_{1.2}Na_{0.4}Gd_{0.4}MgWO₆:0.5% Mn⁴⁺ was prepared by grinding the sample into powder again after cooling to room temperature.

### Experimental Example 4

0.2492 g of CaCO₃ (purity: 99%), 0.0660 g of Na₂CO₃ (purity: 99.8%), 0.2256 g of Gd₂O₃ (purity: 99%), 0.1003 g of MgO (purity: 99.9%), 0.6315 g of (NH₄)₁₀H₂(W₂O₇)₆ (purity: 99.95%) and 0.0015 g of MnCO₃ (purity: 99.95%) were weighed respectively according to the chemical formula CaNa_{0.5}Gd_{0.5}MgWO₆:0.5% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor CaNa_{0.5}Gd_{0.5}MgWO₆:0.5% Mn⁴⁺ was prepared by grinding the sample into powder again after cooling to room temperature.

### Experimental Example 5

0.1945 g of CaCO₃ (purity: 99%), 0.0772 g of Na₂CO₃ (purity: 99.8%), 0.2641 g of Gd₂O₃ (purity: 99%), 0.0979 g of MgO (purity: 99.9%), 0.6162 g of (NH₄)₁₀H₂(W₂O₇)₆ (purity: 99.95%) and 0.0015 g of MnCO₃ (purity: 99.95%) were weighed respectively according to the chemical formula Ca_{0.8}Na_{0.6}Gd_{0.6}MgWO₆:0.5% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.8}Na_{0.6}Gd_{0.6}MgWO₆:0.5% Mn⁴⁺ was prepared by grinding the sample into powder again after cooling to room temperature.

### Experimental Example 6

0.1424 g of CaCO₃ (purity: 99%), 0.0880 g of Na₂CO₃ (purity: 99.8%), 0.3008 g of Gd₂O₃ (purity: 99%), 0.0956 g of MgO (purity: 99.9%), 0.6016 g of (NH₄)₁₀H₂(W₂O₇)₆ (purity: 99.95%) and 0.0015 g of MnCO₃ (purity: 99.95%) were weighed respectively according to the chemical formula Ca_{0.6}Na_{0.7}Gd_{0.7}MgWO₆:0.5% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.6}Na_{0.7}Gd_{0.7}MgWO₆:0.5% Mn⁴⁺ was prepared by grinding the sample into powder again after cooling to room temperature.

### Experimental Example 7

40 g of the phosphor prepared in experimental example 5 and 200 g of polypropylene (PP) material were weighed and mixed uniformly in the inter mixer to a uniform state, and then the mixture was uniformly placed in the 45 mm×45 mm press-film steel plate. Then, the film was pressed twice at a temperature of 200° and a pressure of 14 bar, after cooling, the film was taken out to obtain a light-conversion film that can promote plant growth.

### Experimental Example 8

0.1942 g of CaCO₃ (purity: 99%), 0.0771 g of Na₂CO₃ (purity: 99.8%), 0.2638 g of Gd₂O₃ (purity: 99%), 0.0978 g of MgO (purity: 99.9%), 0.6179 g of (NH₄)₁₀H₂(W₂O₇)₆ (purity: 99.95%) and 0.0003 g of MnCO₃ (purity: 99.95%) were weighed respectively according to the chemical formula Ca_{0.8}Na_{0.6}Gd_{0.6}MgWO₆:0.1% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.5}Na_{0.6}Gd_{0.6}MgWO₆:0.1% Mn⁴⁺ was prepared by grinding the sample into powder again after cooling to room temperature.

### Experimental Example 9

0.1944 g of CaCO₃ (purity: 99%), 0.0772 g of Na₂CO₃ (purity: 99.8%), 0.2640 g of Gd₂O₃ (purity: 99%), 0.0978 g of MgO (purity: 99.9%), 0.6170 g of (NH₄)₁₀H₂(W₂O₇)₆ (purity: 99.95%) and 0.0008 g of MnCO₃ (purity: 99.95%) were weighed respectively according to the chemical formula Ca_{0.8}Na_{0.6}Gd_{0.6}MgWO₆:0.3% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.8}Na_{0.6}Gd_{0.6}MgWO6:0.3% Mn⁴⁺ was prepared by grinding the sample into powder again after cooling to room temperature.

### Experimental Example 10

0.1946 g of CaCO₃ (purity: 99%), 0.0773 g of Na₂CO₃ (purity: 99.8%), 0.2643 g of Gd₂O₃ (purity: 99%), 0.0979 g of MgO (purity: 99.9%), 0.6153 g of (NH₄)₁₀H₂(W₂O₇)₆ (purity: 99.95%) and 0.0020 g of MnCO₃ (purity: 99.95%) were weighed respectively according to the chemical formula Ca_{0.8}Na_{0.6}Gd_{0.6}MgWO₆:0.7% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.8}Na_{0.6}Gd_{0.6}MgWO₆:0.7% Mn⁴⁺ was prepared by grinding the sample into powder again after cooling to room temperature.

### Experimental Example 11

0.1947 g of CaCO₃ (purity: 99%), 0.0773 g of Na₂CO₃ (purity: 99.8%), 0.2645 g of Gd₂O₃ (purity: 99%), 0.0980 g of MgO (purity: 99.9%), 0.6145 g of (NH₄)₁₀H₂(W₂O₇)₆ (purity: 99.95%) and 0.0025 g of MnCO₃ (purity: 99.95%) were weighed respectively according to the chemical formula Ca_{0.8}Na_{0.6}Gd_{0.6}MgWO₆:0.9% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.8}Na_{0.6}Gd_{0.6}MgWO₆:0.9% Mn⁴⁺ was prepared by grinding the sample into powder again after cooling to room temperature.

### Experimental Example 12

0.1949 g of CaCO₃ (purity: 99%), 0.0789 g of Na₂CO₃ (purity: 99.8%), 0.2646 g of Gd₂O₃ (purity: 99%), 0.0981 g of MgO (purity: 99.9%), 0.6136 g of (NH₄)₁₀H₂(W₂O₇)₆ (purity: 99.95%) and 0.0031 g of MnCO₃ (purity: 99.95%) were weighed respectively according to the chemical formula Ca_{0.8}Na_{0.6}Gd_{0.6}MgWO₆:1.1% Mn⁴⁺ in the stoichiometric ratio of Ca, Na, Gd, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.8}Na_{0.6}Gd_{0.6}MgWO₆:1.1% Mn⁴⁺ was prepared by grinding the sample into powder again after cooling to room temperature.

### Experimental Example 13

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0250 g of (2 wt %) sodium fluoride (NaF) flux were weighed respectively according to the stoichiometric ratio shown in the chemical formula Ca_{0.8}Na_{0.6}Gd_{0.6}MgWO₆:0.5% Mn⁴⁺. And then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca_{0.8}Na_{0.6}Gd_{0.6}MgWO₆:1.1% Mn⁴⁺ was prepared by grinding the sample into powder again after cooling to room temperature.

### Experimental Example 14

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0250 g of (2 wt %) boric acid (H₃BO₃) flux were weighed respectively according to the stoichiometric ratio shown in the chemical formula Ca_{0.8}Na_{0.6}Gd_{0.6}MgWO₆:0.5% Mn⁴⁺. And then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor was prepared by grinding the sample into powder again after cooling to room temperature.

### Experimental Example 15

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0250 g of (2 wt %) ammonium fluoride (NH₄F) flux were weighed respectively according to the stoichiometric ratio shown in the chemical formula Ca_{0.8}Na_{0.6}Gd_{0.6}MgWO₆:0.5% Mn⁴⁺. And then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor was prepared by grinding the sample into powder again after cooling to room temperature.

### Experimental Example 16

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0250 g of (2 wt %) ammonium chloride (NH₄Cl) flux were weighed respectively according to the stoichiometric ratio shown in the chemical formula Ca_{0.8}Na_{0.6}Gd_{0.6}MgWO₆:0.5% Mn⁴⁺. And then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor was prepared by grinding the sample into powder again after cooling to room temperature.

### Experimental Example 17

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0250 g of (2 wt %) gadolinium chloride (GdCl₃) flux were weighed respectively according to the stoichiometric ratio shown in the chemical formula Ca_{0.8}Na_{0.6}Gd_{0.6}MgWO₆:0.5% Mn⁴⁺. And then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor was prepared by grinding the sample into powder again after cooling to room temperature.

### Experimental Example 18

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0250 g of (2 wt %) calcium chloride (CaCl₂) flux were weighed respectively according to the stoichiometric ratio shown in the chemical formula Ca_{0.8}Na_{0.6}Gd_{0.6}MgWO₆:0.5% Mn⁴⁺. And then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor was prepared by grinding the sample into powder again after cooling to room temperature.

### Experimental Example 19

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0250 g of (2 wt %) magnesium chloride (MgCl₂) flux were weighed respectively according to the stoichiometric ratio shown in the chemical formula Ca_{0.8}Na_{0.6}Gd_{0.6}MgWO₆:0.5% Mn⁴⁺. And then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor was prepared by grinding the sample into powder again after cooling to room temperature.

### Comparative Example 1

0.5682 g of CaCO₃ (purity: 99%), 0.1144 g of MgO (purity: 99.9%), 0.7237 g of (NH₄)₁₀H₂(W₂O₇)₆ (purity: 99.95%) and 0.0015 g of MnCO₃ (purity: 99.95%) were weighed respectively according to the chemical formula Ca₂MgWO₆:0.5% Mn⁴⁺ in the stoichiometric ratio of Ca, Mg, W and Mn, and then the raw material components and 2.5 ml ethanol (concentration: 99.97%) were fully ground in agate mortar to micron level to prepare the ground mixed raw materials, the ground mixed raw materials were put into the alumina crucible and calcined in the tube furnace. The holding time was 4 h, the heating rate and cooling rate in the tube furnace were both 5° C./min, the reaction atmosphere was air, and the calcining temperature was 1280° C. The phosphor Ca₂MgWO₆:0.5% Mn⁴⁺ was prepared by grinding the sample into powder again after cooling to room temperature.

### Example 1

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0500 g of (4 wt %) NaF flux were weighed respectively according to the stoichiometric ratio shown in the chemical formula Ca_{0.8}Na_{0.6}Gd_{0.6}MgWO₆:0.5% Mn⁴⁺. And then the raw material components were mixed with 2.5 ml ethanol (concentration: 99.97%) and fully ground in agate mortar to micron level to obtain the mixed raw materials, then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 2

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.0750 g of (6 wt %) NaF flux were weighed respectively according to the stoichiometric ratio shown in the chemical formula Ca_{0.8}Na_{0.6}Gd_{0.6}MgWO₆:0.5% Mn⁴⁺. And then the raw material components were mixed with 2.5 ml ethanol (concentration: 99.97%) and fully ground in agate mortar to micron level to obtain the mixed raw materials, then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 3

CaCO₃ (purity: 99%), Na₂CO₃ (purity: 99.8%), Gd₂O₃ (purity: 99%), MgO (purity: 99.9%), (NH₄)₁₀H₂(W₂O₇)₆ (purity: 99.95%), MnCO₃ (purity: 99.95%) and 0.1001 g of (8 wt %) NaF flux were weighed respectively according to the stoichiometric ratio shown in the chemical formula Ca_{0.8}Na_{0.6}Gd_{0.6}MgWO₆:0.5% Mn⁴⁺. And then the raw material components were mixed with 2.5 ml ethanol (concentration: 99.97%) and fully ground in agate mortar to micron level to obtain the mixed raw materials, then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 4

CaCO₃ (purity: 99%), Na₂CO₃ (purity: 99.8%), Gd₂O₃ (purity :99%), MgO (purity: 99.9%), (NH₄)₁₀H₂(W₂O₇)₆ (purity: 99.95%), MnCO₃ (purity: 99.95%) and 0.1251 g of (10 wt %) NaF flux were weighed respectively according to the stoichiometric ratio shown in the chemical formula Ca_{0.8}Na_{0.6}Gd_{0.6}MgWO₆:0.5% Mn⁴⁺. And then the raw material components were mixed with 2.5 ml ethanol (concentration: 99.97%) and fully ground in agate mortar to micron level to obtain the mixed raw materials, then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 5

0.4304 g of CaCO₃ (purity: 99%), 0.0285 g of Na₂CO₃ (purity: 99.8%), 0.0974 g of Gd₂O₃ (purity: 99%), 0.1083 g of MgO (purity: 99.9%), 0.6839 g of (NH₄)₁₀H₂(W₂O₇)₆ (purity: 99.95%), 0.0006 g of MnCO₃ (purity: 99.95%) and 0.0810 g of (6 wt %) NaF were weighed respectively according to the chemical formula Ca_{1.6}Na_{0.2}Gd_{0.2}MgWO₆:0.2% Mn⁴⁺ in the stoichiometric ratio of Ca, Na, Gd, Mg, W and Mn, and then the raw material components were mixed with 2.5 ml ethanol (concentration: 99.97%) and fully ground in agate mortar to micron level to obtain the mixed raw materials; then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 6

0.3666 g of CaCO₃ (purity: 99%), 0.0416 g of Na₂CO₃ (purity: 99.8%), 0.1423 g of Gd₂O₃ (purity: 99%), 0.1054 g of MgO (purity: 99.9%), 0.6664 g of (NH₄)₁₀H₂(W₂O₇)₆ (purity: 99.95%), 0.0003 g of MnCO₃ (purity: 99.95%) and 0.0529 g of (4 wt %) NaF were weighed respectively according to the chemical formula Ca_{1.4}Na_{0.3}Gd_{0.3}MgWO₆:0.1% Mn⁴⁺ in the stoichiometric ratio of Ca, Na, Gd, Mg, W and Mn, and then the raw material components were mixed with 2.5 ml ethanol (concentration: 99.97%) and fully ground in agate mortar to micron level to obtain the mixed raw materials; then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 7

0.3072 g of CaCO₃ (purity: 99%), 0.0542 g of Na₂CO₃ (purity: 99.8%), 0.1855 g of Gd₂O₃ (purity: 99%), 0.1031 g of MgO (purity: 99.9%), 0.6450 g of (NH₄)₁₀H₂(W₂O₇)₆ (purity: 99.95%), 0.0032 g of MnCO₃ (purity: 99.95%) and 0.0260 g of (2 wt %) NaF were weighed respectively according to the chemical formula Ca_{1.2}Na_{0.4}Gd_{0.4}MgWO₆:1.1% Mn⁴⁺ in the stoichiometric ratio of Ca, Na, Gd, Mg, W and Mn, and then the raw material components were mixed with 2.5 ml ethanol (concentration: 99.97%) and fully ground in agate mortar to micron level to obtain the mixed raw materials; then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 8

0.2492 g of CaCO₃ (purity: 99%), 0.0660 g of Na₂CO₃ (purity: 99.8%), 0.2257 g of Gd₂O₃ (purity: 99%), 0.1004 g of MgO (purity: 99.9%), 0.6311 g of (NH₄)₁₀H₂(W₂O₇)₆ (purity: 99.95%), 0.0017 g of MnCO₃ (purity: 99.95%) and 0.1274 g of (10 wt %) NaF were weighed respectively according to the chemical formula CaNa_{0.5}Gd_{0.5}MgWO₆:0.6% Mn⁴⁺ in the stoichiometric ratio of Ca, Na, Gd, Mg, W and Mn, and then the raw material components were mixed with 2.5 ml ethanol (concentration: 99.97%) and fully ground in agate mortar to micron level to obtain the mixed raw materials; then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 9

0.1946 g of CaCO₃ (purity: 99%), 0.0788 g of Na₂CO₃ (purity: 99.8%), 0.2643 g of Gd₂O₃ (purity: 99%), 0.0979 g of MgO (purity: 99.9%), 0.6153 g of (NH₄)₁₀H₂(W₂O₇)₆ (purity: 99.95%), 0.0020 g of MnCO₃ (purity: 99.95%) and 0.1253 g of (10 wt %) NaF flux were weighed respectively according to the chemical formula Ca_{0.8}Na_{0.6}Gd_{0.6}MgWO₆:0.7% Mn⁴⁺ in the stoichiometric ratio of Ca, Na, Gd, Mg, W and Mn, and then the raw material components were mixed with 2.5 ml ethanol (concentration: 99.97%) and fully ground in agate mortar to micron level to obtain the mixed raw materials; then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

### Example 10

0.4306 g of CaCO₃ (purity: 99%), 0.0285 g of Na₂CO₃ (purity: 99.8%), 0.0975 g of Gd₂O₃ (purity: 99%), 0.1084 g of MgO (purity: 99.9%), 0.6835 g of (NH₄)₁₀H₂(W₂O₇)₆ (purity: 99.95%), 0.0009 g of MnCO₃ (purity: 99.95%) and 0.0810 g of (8 wt %) NaF flux were weighed respectively according to the chemical formula Ca_{1.6}Na_{0.2}Gd_{0.2}MgWO₆:0.3% Mn⁴⁺ in the stoichiometric ratio of Ca, Na, Gd, Mg, W and Mn, and then the raw material components were mixed with 2.5 ml ethanol (concentration: 99.97%) and fully ground in agate mortar to micron level to obtain the mixed raw materials; then the prepared mixed raw materials were placed in the tube furnace at a heating rate of 5° C./min to 1280° C. and the temperature was held for 4 hours, then cooled in the furnace to room temperature to obtain the calcined product. And the phosphor was obtained by grinding the calcined product.

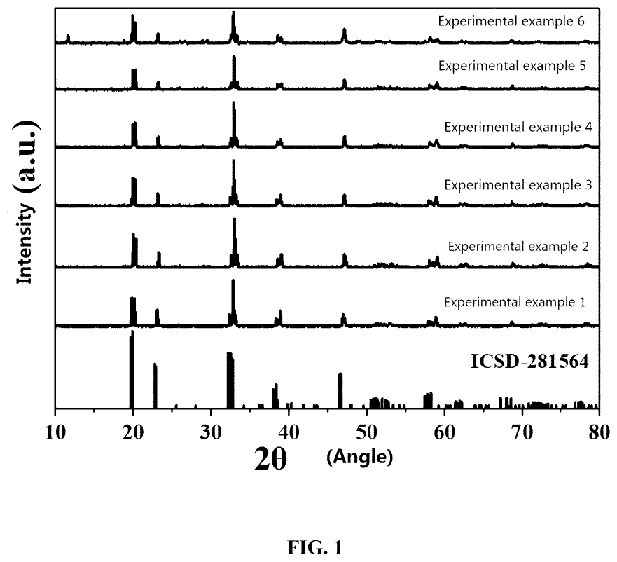

The comparison diagram of the XRD pattern and the standard powder diffraction file of the deep red phosphor for plant growth prepared in experimental examples 1-6. As shown in FIG. 1, when x≤0.6, the prepared diffraction peaks of the red phosphor correspond to the standard data card one-to-one, and no other impurity peaks were observed, indicating that the solid solution limit of the phosphor is Ca_{0.8}Na_{0.6}Gd_{0.6}MgWO₆, and all were pure phases.

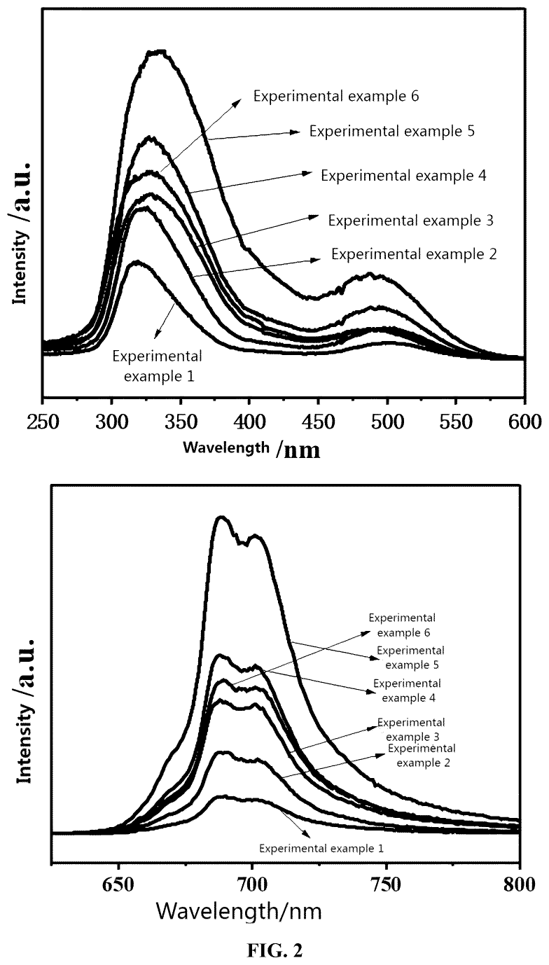

FIG. 2 is the excitation and the emission spectrum of the deep red phosphor for plant growth prepared in experimental examples 1-6. As can be seen from the figure, under the excitation condition of 370 nm, the emission spectrum of the phosphor is in the range of 600-800nm, the emission spectrum peaks of experimental example 1 ,experimental example 2, experimental example 3, experimental example 4, experimental example 5 and experimental example 6 were all at 688 nm respectively. It was shown that the emission colors of the phosphors prepared in experimental example 1, experimental example 2, experimental example 3, experimental example 4, experimental example 5 and experimental example 6 were all red. The excitation-emission intensity increased first and then decreased, in which experimental example 5 had the highest emission intensity.

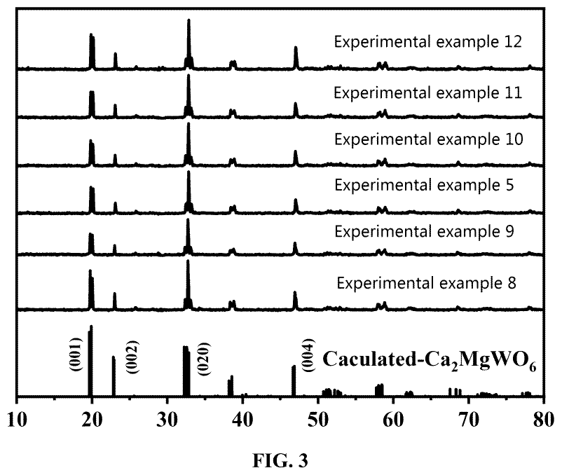

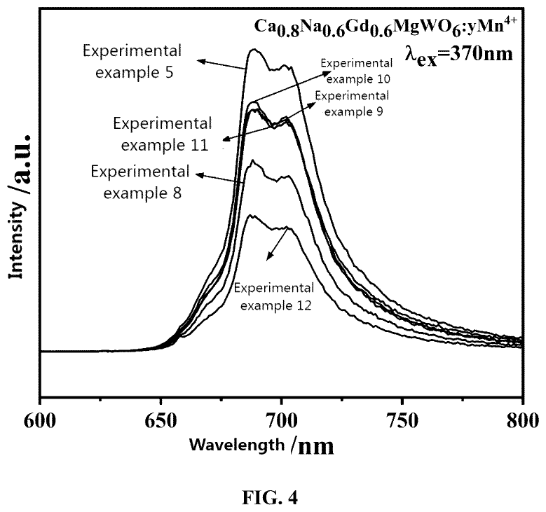

FIG. 3 is the comparison diagram of the XRD pattern and the standard powder diffraction file of the deep red phosphor for plant growth prepared in experimental examples 5 and 8-12. As shown in FIG. 3, the diffraction peaks of all samples correspond with the calculated data one-to-one, and no impurity peaks were observed, indicating that the samples were single-phase. FIG. 4 is the emission spectrum of the deep red phosphor for plant growth prepared in experimental examples 5 and 8-12. As shown in FIG. 4, under 370 nm excitation, the emission spectrum of the Ca_{0.8}Na_{0.6}Gd_{0.6}MgWO₆:yMn⁴⁺ series samples all showed narrow-band emission around 600-800 nm, as the Mn⁴⁺ concentration increases, its emission intensity increased first and then decreased, reaching maximum intensity at approximately y=0.5% Mn⁴⁺ ion concentration, the higher Mn⁴⁺ concentrations may induce interactions between excited molecules or ions, which could lead to energy transfer and luminescence quenching.

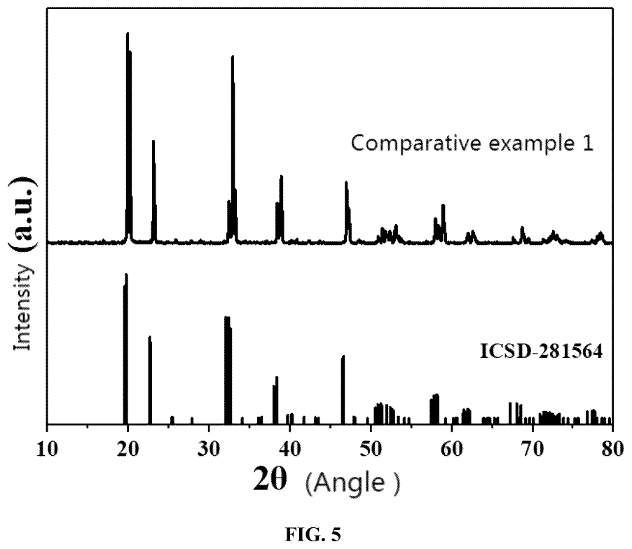

FIG. 5 is the comparison diagram of the XRD pattern and the standard powder diffraction file of the phosphor prepared in comparative example 1. All diffraction peaks can correspond with the standard powder diffraction file one-to-one, and no other impurity peaks were observed. The result showed that the pure-phase product was successfully prepared.

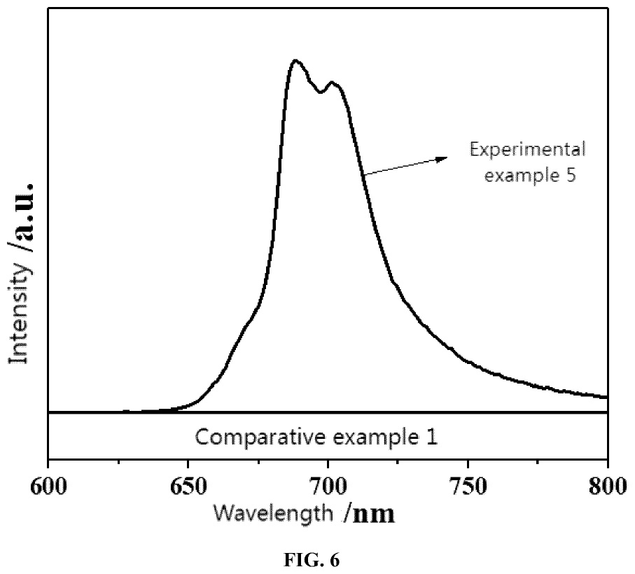

FIG. 6 is the comparison diagram of the emission spectrum of the phosphor in experimental example 5 and comparative example 1. Under 370 nm excitation, the emission spectrum of the phosphor is in the 600-800 nm range, indicating that the phosphor prepared by the present invention was red phosphor. The luminescence intensity of the phosphor prepared by experimental example 5 exceeded the luminescence intensity of the phosphor prepared by comparative example 1 by more than 10-fold under identical excitation conditions, indicating that aliovalent ion substitution effectively enhanced phosphor luminescence intensity.

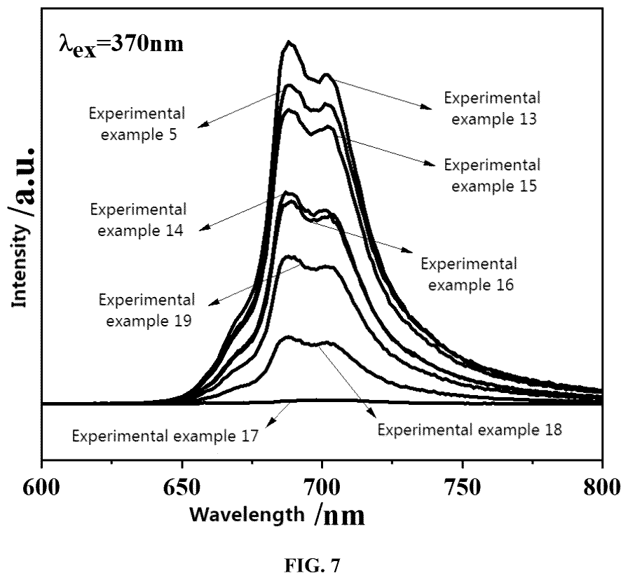

FIG. 7 is the emission spectrum of the deep red phosphor for plant growth prepared in experimental examples 5 and 13-19. As shown in FIG. 7, on the basis of the phosphors prepared by the experimental example 5, seven fluxes such as NaF, H₃BO₃, NH₄F, NH₄Cl, GdCl₃, CaCl₂, and MgCl₂ were added respectively. Among these, only the luminescence performance of experimental example 13 with NaF flux showed significant luminescence enhancement compared to the emission intensity of the phosphor prepared in experimental example 5, while all other flux additives resulted in reduced luminescence intensity.

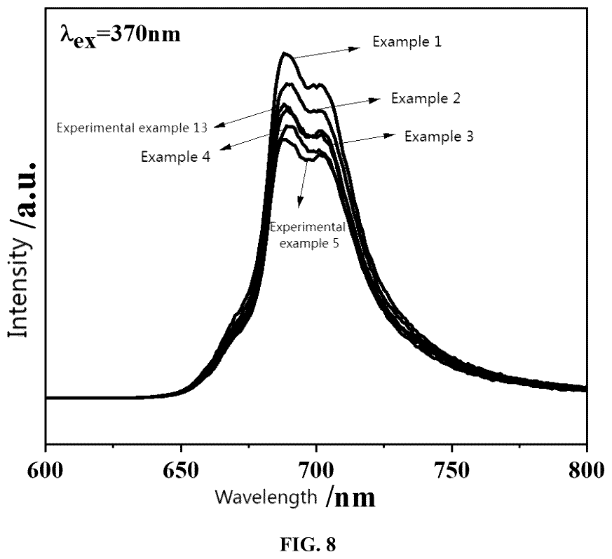

FIG. 8 is the emission spectrum of the deep red phosphor for plant growth prepared in experimental examples 5, 13 and examples 1-4. NaF flux was selected for the concentration gradient experiment, and under 370 nm excitation, as the concentration of NaF flux increased, the luminescence intensity of the phosphor showed a trend of increasing first and then decreasing. The highest luminescence intensity was observed in the phosphor with 4% wt NaF added, while the phosphors prepared in examples 2-4 showed a decrease in luminescence intensity due to the impurity caused by the introduction of excess Na⁺.

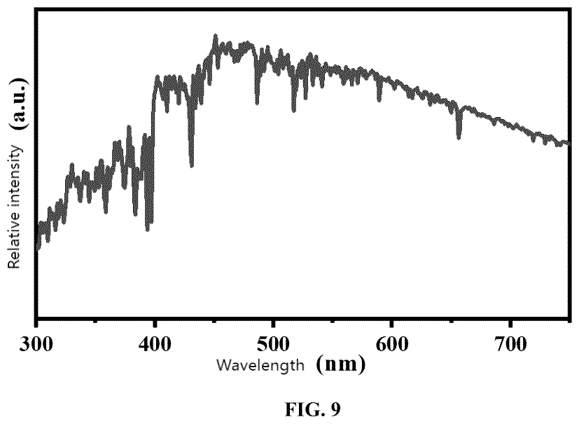

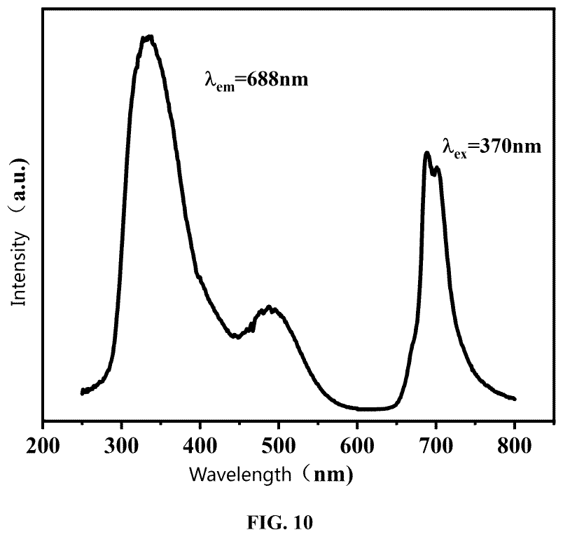

FIG. 9 is the spectrum diagram of sunlight, indicating that the blue light portion has the highest intensity in the sunlight. Based on the regulation of luminescence performance, a novel deep red phosphor Ca_{0.8}Na_{0.6}Gd_{0.6}MgWO₆:0.5% Mn⁴⁺ has been successfully prepared by the present invention, and this phosphor can be effectively excited by blue light, which emits red light in the 600-800 nm range, as shown in FIG. 10. In terms of plant growth: red light in the 600-700 nm range mainly promotes photosynthesis, germination, flowering, and fruiting in plants, while red light above 700 nm overlaps well with photosensitive pigments in plants, playing an important auxiliary role in plant growth and is also indispensable. Therefore, the phosphor of the present invention for plant growth optimally fits the red light requirements of plant growth. The light-conversion film prepared with the phosphor of the present invention can be directly excited by sunlight and emit red light to promote plant growth.

Based on the above theoretical analysis, a growth experiment of lettuce was performed:

Lettuce has a preference for cool environments, with an optimal growth temperature of 15-20° C., so the experiment was scheduled for January-February 2024, lettuce has a cultivation cycle of approximately 20-30 days, while most plants have a long growth cycle, providing convenience for the experiment, so the experiment was scheduled for January-February 2024.

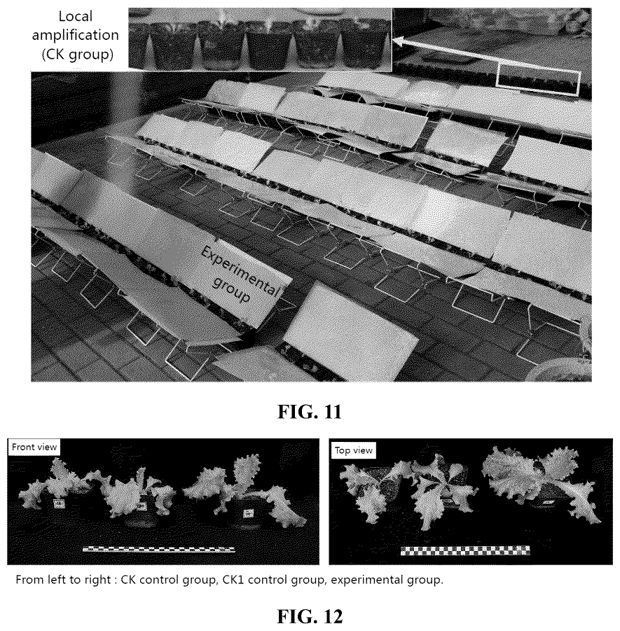

FIG. 11 is the experimental diagram of promoting lettuce growth using the light-conversion film, the mass percentage of phosphors in the light-conversion film of the experimental group was 20%, while the CK group served as the blank control group. Two light-conversion films were placed at the bottom of the lettuce plants, with each light-conversion film positioned on both sides of the lettuce plants, and the angle between the light-conversion film and the horizontal plane was between 25°-45°. The experiment of the light-conversion film was performed at the three-leaf and one-heart stage of lettuce. After 21 days of growth, the maturity of the lettuce leaves of the CK control group and the experimental group was shown in FIG. 12. It can be clearly seen from the figure that the lettuce leaves in the experimental group were wider than the lettuce leaves in the CK control group. After measuring the biomass, the biomass of the experimental group was significantly increased compared with CK, with dry weight and fresh weight increasing by 81.49% and 57.49%, respectively. Based on the above experimental results and data, it was shown that the effects of advancing maturity and increased yield can be achieved by using light-conversion film to cultivate lettuce.

It can be seen that the light-conversion film synthesized by using the phosphor Ca_{0.8}Na_{0.6}Gd_{0.6}MgWO₆:Mn⁴⁺ of the present invention and PP can increase plant yield and advance maturity. Therefore, the light-conversion film prepared by using the phosphor of the present invention has a highly effective promoting effect on plant growth, and this light-conversion film has potential for commercial application.

Therefore, the present invention provides a phosphor for promoting plant growth, preparation method, using method and application thereof, the phosphor prepared by the present invention can emit deep red light under the irradiation of near-ultraviolet light and sunlight. An excitation spectrum of the phosphor basically covers the entire visible light region, which can effectively convert sunlight into the red light required by plants, improve the utilization rate of sunlight by plants, and promote plant growth. Furthermore, given the advantages of inexpensive, readily available, and pollution-free for raw materials, simple and mild for preparation method, and low production costs, which are suitable for large-scale industrial production, it is possible to prepare phosphors with good luminescence efficiency and suitable for plant growth under more favorable reaction conditions.

In the descriptions of this specification, the terms such as ‘an experimental example,’ ‘example,’ and ‘specific example’ refer to the specific features, structures, materials, or characteristics described in the experimental example or example being combined with at least one experimental example or example of the present invention. In this specification, the illustrative use of the above terms does not necessarily refer to the same experimental example or example. Furthermore, the specific features, structures, materials, or characteristics described may be appropriately combined in any one or more of the experimental examples or examples.

Finally, it should be noted that the above experimental examples are merely used for describing the technical solutions of the present invention, rather than limiting the same. Although the present invention has been described in detail with reference to the preferred experimental examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A phosphor for promoting plant growth, wherein a chemical expression of the phosphor is Ca₂₋₂ₓNaₓGdₓMgWO₆:yMn⁴⁺, wherein 0.1≤x≤0.6, 0.1%≤y≤1.1%.

2. The phosphor for promoting plant growth according to claim 1, wherein a chemical expression of the phosphor is Ca_{0.8}Na_{0.6}Gd_{0.6}MgWO₆:0.5% Mn⁴⁺.

3. A method of use of the phosphor for promoting plant growth according to claim 1, wherein a light-conversion film made of the phosphor converts received sunlight into red light in a wavelength range of 600-800 nm.

4. A method of preparing the phosphor for promoting plant growth of claim 1 comprising the following steps:
S1, weighing raw materials according to the general chemical formula Ca₂₋₂ₓNaₓGdₓMgWO₆:yMn⁴⁺, 0.1≤x≤0.6, 0.1%≤y≤1.1% in a stoichiometric ratio, wherein the raw materials comprise calcium compounds, sodium compounds, gadolinium compounds, magnesium compounds, tungsten compounds and manganese compounds, mixing the above compounds uniformly, adding a flux, and then mixing with ethanol to obtain mixed raw materials by grinding and drying;
S2, placing the mixed raw materials prepared in step S1 in a tube furnace at a heating rate of 5° C./min to 1280° C., holding the temperature for 4 hours, and then cooling in the furnace to room temperature to obtain a calcined product; and
S3, obtaining the phosphor by grinding the calcined product.

5. The method of preparing the phosphor for promoting plant growth according to claim 4, wherein the calcium compounds comprise one or more of calcium carbonate, hydroxides of calcium, nitrates of calcium, carbonates of calcium, sulfates of calcium, and phosphates of calcium; wherein:
the sodium compounds comprise one or more of sodium carbonate, hydroxides of sodium, nitrates of sodium, carbonates of sodium, sulfates of sodium, or phosphates of sodium;
the magnesium compounds comprise one or more of magnesium oxide, hydroxides of magnesium, nitrates of magnesium, carbonates of magnesium, sulfates of magnesium, and phosphates of magnesium;
the gadolinium compounds comprise one or more of gadolinium oxide, hydroxides of gadolinium, nitrates of gadolinium, carbonates of gadolinium, sulfates of gadolinium, and phosphates of gadolinium;
the tungsten compounds comprise one or more of ammonium tungstate, hydroxides of tungsten, nitrates of tungsten, carbonates of tungsten, sulfates of tungsten, and phosphates of tungsten; and
the manganese compounds comprise one or more of manganese carbonate, hydroxides of manganese, nitrates of manganese, carbonates of manganese, sulfates of manganese, and phosphates of manganese.

6. The method of preparing the phosphor for promoting plant growth according to claim 4, wherein the flux is 2-10 wt % sodium fluoride.

7. The method of use of the phosphor for promoting plant growth in plant growth according to claim 1, comprising using the phosphor to convert received sunlight into red light in a wavelength range of 600-800 nm.

8. The method of use of the phosphor for promoting plant growth in plant growth according to claim 2, comprising using the phosphor to convert received sunlight into red light in a wavelength range of 600-800 nm.

9. The method of use of the phosphor for promoting plant growth in plant growth according to claim 7, wherein the phosphor is made into a light-conversion film when used for lettuce growth, and at least two of the light-conversion films are uniformly arranged around a bottom of the lettuce plant and other placement manners, an angle between the light-conversion film and a horizontal plane is between 25°-45°.

10. The method of use of the phosphor for promoting plant growth in plant growth according to claim 8, wherein the phosphor is made into a light-conversion film when used for lettuce growth, and at least two of the light-conversion films are uniformly arranged around a bottom of the lettuce plant and other placement manners, an angle between the light-conversion film and a horizontal plane is between 25°-45°.
